(19) United States
(12) Patent Application Publication
(10) Pub. No.: US 2011/0246193 A1
(43) Pub. Date: Oct. 6, 2011

(54) SIGNAL SEPARATION METHOD, AND COMMUNICATION SYSTEM SPEECH RECOGNITION SYSTEM USING THE SIGNAL SEPARATION METHOD

(76) Inventor: Ho-Joon Shin, Seoul (KR)

(21) Appl. No.: 13/139,184

(22) PCT Filed: Nov. 26, 2009
(86) PCT No.: PCT/KR09/07014

§ 371 Date: Jun. 10, 2011

(30) Foreign Application Priority Data
Dec. 12, 2008 (US) 61/122204

(51) Int. Cl. G10L 15/20

(52) U.S. Cl. 704/233; 704/E15.039

(57) ABSTRACT

A method for signal separation, communication system, and voice recognition system using the method are disclosed. The method which is performed by an apparatus for signal separation includes receiving a mixed signal, wherein a first signal based on a first sound source signal and a second signal based on a second sound source signal are mixed, via a single voice input sensor, applying the modified BSS algorithm for separating the first sound source signal and the second sound source signal based on the received mixed signal, and separating the first sound source signal according to the result of applying the modified BSS algorithm.

### BACKGROUND

The present inventive concept relates to a method for signal separation, a communication system and a voice recognition system using the method, and more particularly, to, when one of the two sound source signals is known and the other is unknown, a method for separating one signal from the two signals and removing the separated signal, so that only a desired signal is received, and a system using the method.

In daily life, various sounds may be heard. Some sounds like beautiful music are pleasant and the other sounds like a car noise are unpleasant. But even beautiful music may be considered noise in unwanted circumstances. For example, a piano sound from a neighbor upstairs may be always noise. In case of a phone call during listening music, the music becomes mere noise disturbing the call. When commanding to a car's navigation system by voice control, music is no longer the desired signal.

Likewise, most of the voice-related systems should ideally receive only the desired signal. However, noise, reverberation and other environmental disturbances are input together with the desired signal into a microphone. A variety of techniques such as Microphone Array, Noise Reduction, Acoustic Echo Cancel, and Blind Source Separation have been researched and developed to eliminate noise and reverberation.

Unknown noise, known noise, and reverberation must to be removed to obtain only the desired signal. The technology used for the commercial model has been implemented to remove unknown noise, whereas, the technology that removes known noise and reverberation is under research or has not been commercialized. Even it has been commercialized, it may not work well. When acoustic echoes occur, conventional voice communication systems (for example, a mobile phone) applied a method of removing the noise using the Least Mean Square (Hereinafter, referred to as LMS) method and avoiding therefrom by composing a half-duplex communication system, but the method had poor efficiency and was not proper to be applied to a voice recognition system. Also, in case of applying Blind Source Separation (Hereinafter, referred to as BSS) method for separating two sound source signals, a complexity of the operation is so high that the desired signals may not be easily separated from the other signal in real time.

In addition, for conventional voice recognition systems (for example, (IP)TV, HAS(Home automation system), navigation, and robot), since a voice signal which comes out of the system itself was mixed with a user's voice order and input to the voice recognition system, the process to lower the loudness of the voice signal or to enter a separate mode to identify the voice order before receiving the voice order was required.

Thus, a method for separating only the desired signal from the mixed signals in real time while being applicable to both communication system (for example, voice communication system) and voice recognition system (for example, HAS(Home automation system), navigation, robot) in common, and systems using the method are required.

### SUMMARY

The inventive concept provides a method for separating a desired signal from a mixed signal in which at least two signals are mixed efficiently in real time, and a system using the method.

A method for separating a signal adaptable to the system that requires to separate a desired signal in real time, such as cell phone or voice recognition system, etc., and a system using the method are also provided. While in the conventional BSS algorithm, at least two different voice recognition sensors were needed for separating at least two sound source signals, in some embodiments of the present inventive concept, the method for separating a desired signal from sound source signals by using voice recognition sensor (for example, microphone) of the number smaller than the number of sound sources is provided.

According to some exemplary embodiments of the present inventive concept, there is provided a method for signal separation which is performed by an apparatus for signal separation of receiving a mixed signal, wherein a first signal based on a first sound source signal and a second source signal based on a second sound source signal are mixed, via a single voice input sensor based on the received mixed signal, applying a modified BSS algorithm for separating the first sound source signal and the second sound source signal with one another, and separating the first sound source signal according to the result of applying the modified BSS algorithm.

The second sound source signal is the signal to be output via a voice output sensor included in the apparatus for signal separation.

The modified BSS algorithm is for applying BSS algorithm when the first sound source signal and the second sound source signal are a first BSS sound source signal and a second BSS sound source signal, respectively, a mixed signal input via the voice input sensor is a first BSS input signal, and an output signal output via the voice output sensor is a second BSS input signal.

The first BSS input signal and the second BSS input signal may be expressed by Equation 1, respectively.

x₁(t)=a₁₁s₁(t)+a₁₂s₂(t)

x₂(t)=a₂₂s₂(t) [Equation 1]

The first sound source signal and the second sound source signal may be expressed by Equation 2, respectively.

s₁(t)=w₁₁x₁(t)+w₁₂x₂₂(t)

s₂(t)=w₂₂x₂(t) [Equation 2]

The function W may be expressed by Equation 3.

$$W ( ω ) = [ \begin{matrix}1 & {w}_{12} \\ 0 & 1\end{matrix} ] \qquad [ Equation 3 ]$$

The apparatus for signal separation may be embodied as a communication system, wherein the first sound source signal is a user's voice signal and the second sound source signal is the signal to be output via a voice output sensor based on voice information received from other communication system.

The method may further include storing the voice information, wherein the storing is performed by the apparatus for signal separation.

The apparatus for signal separation may be embodied as a voice recognition system, wherein the first sound source signal may be processed as a voice recognition order.

The voice input sensor may be embodied as a micro-phone. The method for signal separation may be stored to a computer readable recording medium which a program is recorded thereon.

According to another exemplary embodiment of the present inventive concept, there is provided a communication system including a voice input sensor and a control module. The communication system receives a mixed signal wherein a first signal based on a first sound source signal and a second signal based on a second sound source signal are mixed via the voice input sensor. The control module applies the modified BSS algorithm for separating the first sound source signal based on the received mixed signal, and thereafter separates the first sound source signal based on the result of applying the modified BSS algorithm.

The communication system further includes a voice output sensor. The second sound source signal is the signal to be output via the voice output sensor.

The communication system further includes a network interface module. The communication system transmits the first sound source signal to other communication system via the network interface module.

The modified BSS algorithm is for applying BSS algorithm when the first sound source signal and the second sound source signal are a first BSS sound source signal and a second BSS sound source signal, respectively, a mixed signal input via the voice input sensor is a first BSS input signal, and an output signal output via the voice output sensor is a second BSS input signal. The communication system may be embodied as at least one of wire/wireless telephone, mobile phone, computer, IPTV, IP phone, Bluetooth communication apparatus, and a conference call.

According to yet another exemplary embodiment of the inventive concept, there is provided a voice recognition system including a voice input sensor, a voice output sensor and a control module. The voice recognition system receives a mixed signal wherein a first signal based on a first sound source signal and a second signal based on a second sound source signal are mixed via the voice input sensor. The control module applies the modified BSS algorithm for separating the first sound source signal based the mixed signal, and thereafter separates the first sound source signal based on the result of applying the modified BSS algorithm.

The modified BSS algorithm is for applying BSS algorithm when the first sound source signal and the second sound source signal are a first BSS sound source signal and a second BSS sound source signal, respectively, a mixed signal input via the voice input sensor is a first BSS input signal, and an output signal output via the voice output sensor is a second BSS input signal.

The voice recognition system processes the first sound source signal as voice order and performs an operation corresponding thereto.

The voice recognition system may be embodied as at least one of navigation, TV, IPTV, conference call, home network system, robot, game machine, electronic dictionary, and language learning machine.

### BRIEF DESCRIPTION OF THE DRAWINGS

Exemplary embodiments of the inventive concept will be more clearly understood from the following detailed description taken in conjunction with the accompanying drawings in which:

FIG. 1 is a diagram illustrating a forward model of general BBS algorithm;

FIG. 2 is a diagram illustrating a backward model of general BBS algorithm;

FIG. 3 is a conceptual diagram of a forward model of modified BBS algorithm, according to an exemplary embodiment of the present inventive concept;

FIG. 4 is a conceptual diagram of a backward model of the modified BBS algorithm shown in FIG. 3 according to some exemplary embodiments of the present inventive concept;

FIG. 5 is a schematic diagram of a communication system according to another exemplary embodiment of the present inventive concept;

FIG. 6 is a schematic diagram of a voice recognition system according to yet another exemplary embodiment of the present inventive concept; and

FIG. 7 through FIG. 12 are diagrams for explaining test outcomes of performing signal separation by applying the method for signal separation according to some exemplary embodiments of the present inventive concept.

### DETAILED DESCRIPTION OF THE EMBODIMENTS

The attached drawings for illustrating exemplary embodiments of the inventive concept are referred to in order to gain a sufficient understanding of the inventive concept and the merits thereof. Hereinafter, the inventive concept will be described in detail by explaining exemplary embodiments of the inventive concept with reference to the attached drawings. Like reference numerals in the drawings denote like elements.

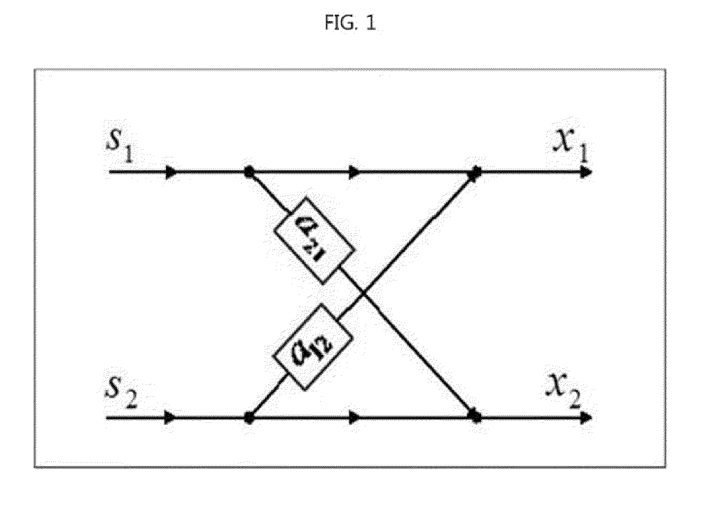

FIG. 1 is a diagram of a forward model of general BSS algorithm. Referring to FIG. 1, the purpose of general BSS algorithm is, when sounds from at least two original sound sources (S1, S2, etc) are mixed, to estimate sound source signals of the sound sources (S1, S2, etc.) from input signals (x1, x2, etc.). To separate signals output from n sound sources, at least n of input signal (for example, x1, x2 . . . , xn) is required. As the simplest model, it may be assumed that input signals x1, x2 input from two sound sources S1, S2 and two microphones (not shown) exist as shown in FIG. 1.

When it is assumed that sound source signals of sound sources S1, S2 are s(t)=[s₁(t),s₂(t)]^{T}, and input signals input from each microphone are x(t)=[x₁(t),x₂(t)]^{T}, each input signal may be expressed by Equation 1.

x₁(t)=a₁₁s₁(t)+a₁₂s₂(t)

x₂(t)=a₂₁s₁(t)+a₂₂s₂(t) [Equation 1]

where a₁₁, a₁₂, a₂₁, a₂₂ are gain factors depending on the distances of the microphones from each sound source.

Using a matrix notation, the Equation 1 may be expressed by Equation 2.

x(t)=As(t) [Equation 2]

where the matrix A may be a gain matrix.

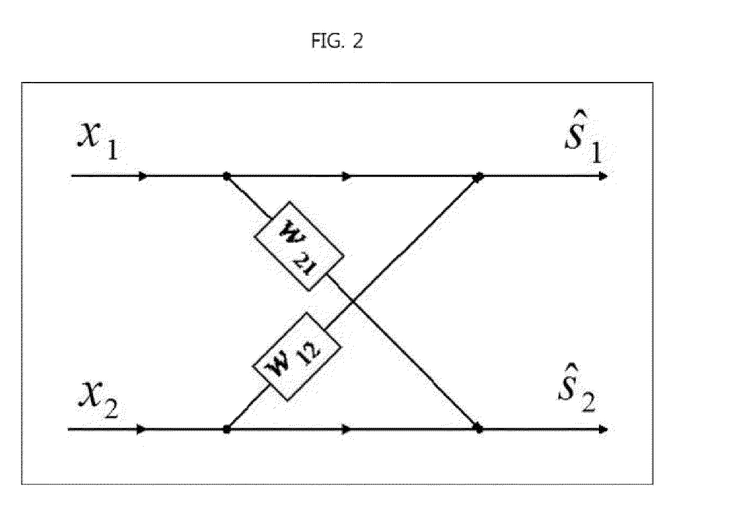

Meanwhile, a backward model of relationship between sound sources and input signals shown in FIG. 1 is shown in FIG. 2. FIG. 2 is a diagram of a backward model of the BSS algorithm. Referring to FIG. 2, when Equation 2 expresses the relationship between sound source signal and input signal in the forward model shown in FIG. 1, that in the backward model in FIG. 2 may be expressed by Equation 3.

ŝ(t)=Wx(t)=WAs(t) [Equation 3]
where the matrix W is the inverse matrix of A, and ŝ(t) denotes original sound source signals.

In Equation 3, it is assumed that only the level of sound pressure is considered. Delay time between microphones and sound sources and other factors may be negligible. And, it is also assumed that each sound source is not correlated and has independent signals.

More commonly, when input signals from m sound sources are received by m microphones, respectively, it is assumed that the input signals are input via a number of paths with delay time is considered. When background noise is n(t), the input signals may be expressed by Equation 4.

$$x ( t ) = {\sum }_{τ = 0}^{P} A ( τ ) s ( t - τ ) + n ( t ) \qquad [ Equation 4 ]$$

where P is convolution order and A(τ) is m×m mixing matrix.

Under the assumption that there is less effect from the reverberation, it may be assumed that input signals from each microphone are independent with one another. And, when it is assumed that the background noise n(t) is not correlated with the sound sources and may be removed by using convolution theorem, ŝ(t) may be estimated from x(t) by Equation 5.

$$\hat{s} ( t ) = {\sum }_{τ = 0}^{Q} W ( τ ) x ( t - τ ) \qquad [ Equation 5 ]$$

where Q is filter length.

For convenience of calculating, the liner convolution undergone Short Time Fourier Transform (STFT) process that has frame size T (T>>P, convolution order) may be expressed by Equation 6.

X(ω,t)≅A(ω)S(ω,t) [Equation 6]

where W is a frequency.

And the cross-correlation between the input signal and sound sources may be obtained by Equation 7.

\hat{R}ₓ(ω,t)=E[X(ω,t)X^{H}(ω,t)]

\hat{Λ}ₛ(ω,t)=E[S(ω,t)S^{H}(ω,t)] [Equation 7]

where \hat{Λ}ₛ denotes a matrix of the estimated sound sources with respect to the original sound sources.

Also, \hat{Λ}ₛ may be expressed by Equation 8 by using the relationship between ŝ(t) and x(t).

$$\begin{matrix}{\hat{Λ}}_{s} ( ω , t ) = E [ W ( ω ) X ( ω , t ) {X}^{H} ( ω , t ) {W}^{H} ( ω ) ] \\ = W ( ω ) {\hat{R}}_{x} ( ω , t ) {W}^{H} ( ω )\end{matrix} \qquad [ Equation 8 ]$$

where \hat{R}ₓ denotes a cross-correlation function.

The difference E between the estimated signal \hat{Λ}ₛ and the sound source signal \hat{Λ}ₛ may be expressed by Equation 9.

E(ω,t)=W(ω)\hat{R}ₓ(ω,t)W^{H}(ω)−Λ_{S} [Equation 9]

w(ω) may be obtained by using Least Square Estimation as Equation 10.

$$\hat{W} , {\hat{Λ}}_{s} = arg {min}_{\hat{W} , {\hat{Λ}}_{s}} {\sum }_{t} {\sum }_{ω = 1}^{T} {‖ E ( ω , t ) ‖}^{2}$$

$$s . t . W ( τ ) = 0 , ∀ τ > Q , Q ≪ T$$

$${W}_{ii} ( ω ) = 1$$

where Q is filter length, which needs to be not greater than the frame size T to avoid Frequency Permutation Problem.

If Equation 10 is set to be cost function J, the gradient with respect to W*(ω) results as Equation 11.

$$\frac{\partial J}{\partial {W}^{*} ( ω )} = 2 {\sum }_{t} E ( ω , t ) W ( ω ) {\hat{R}}_{x} ( ω , t ) \qquad [ Equation 11 ]$$

Thus, w(ω) may be finally obtained from Equation 11.

In the BSS algorithm problems as described above, basically the two signals are unknown signals, however, when one of the two signals is a known signal and sets to be a reference signal, the calculation may be much more simplified. The following situation may be assumed. TV, telephone, navigation, video phone, etc. are examples of apparatuses in which microphone and speaker are combined. The speaker always generates sounds. The sound may be a human voice like radio broadcasting or a sound which has broader bandwidths such as music. The sound source signal from a voice output sensor (for example, speaker etc.) is mixed with the desired voice signal such as a user's voice order into a mixed signal. The mixed signal is input via a voice recognition sensor (for example, microphone etc.). But, the required signal is the user's voice order except for the sound signal output from the voice output sensor.

The apparatus for signal separation according may be applied to all of the systems that may receive and transmit a voice signal of a communication system (for example, wire/wireless telephone, mobile phone, conference call, IPTV, IP phone, Bluetooth communication apparatus, computer, etc.) using wire/wireless communication. Also, the apparatus for signal separation may be applied to all of the systems that recognize a voice from external of voice recognition system (for example, TV, IPTV, conference call, navigation, video phone, robot, game machine, electronic dictionary, language learning machine, etc.) and perform a predetermined operation according to the recognized information. As such, the apparatus for signal separation is embodied as communication system and/or voice recognition system, so that the desired signal may be separated from the mixed signal in which a known signal and the desired signal are mixed effectively by using the BSS algorithm.

Such technological theory may be defined as a modified BSS algorithm in the present inventive concept. The modified BSS algorithm, compared to the conventional BSS algorithm, may be applied in a case that the number of voice recognition sensor is not greater than that of sound source, which results in enabling signal separation in real rime thanks to less operation load.

Hereinafter, the modified BSS algorithm according to some exemplary embodiment of present inventive concept will be described by applying the conventional BSS algorithm.

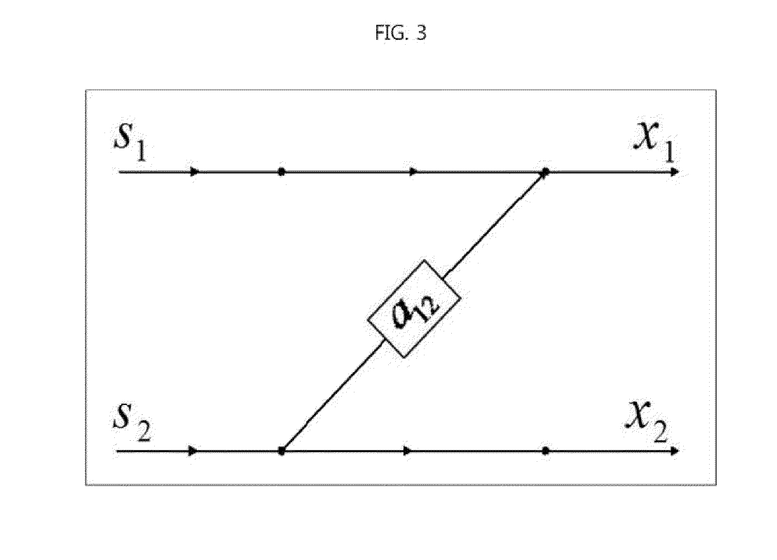

FIG. 3 is a conceptive diagram of a forward model of the modified BSS algorithm according to some exemplary embodiments of the present inventive concept. Referring to FIG. 3, there exists a first sound source S1 (for example, speech) and a second sound source S2 (for example, a speaker), then, a sound source signal of the first sound source S1 may be s₁(t) and the sound source signal of the second sound source S2 may be s₂(t). An input signal which is input via a single voice recognition sensor (for example, microphone, etc.), that is, a mixed signal, may be x₁(t). Since it is assumed that the apparatus for signal separation includes a single voice recognition sensor in an exemplary embodiment of FIG. 3, it may be assumed that the sound source signal output from the second sound source S2 (for example, speaker) is the other input and sets to be x₂(t). Then, Equation 1 described above may be converted into Equation 12.

x₁(t)=a₁₁s₁(t)+a₁₂s₂(t)

x₂(t)=a₂₂s₂(t) [Equation 12]

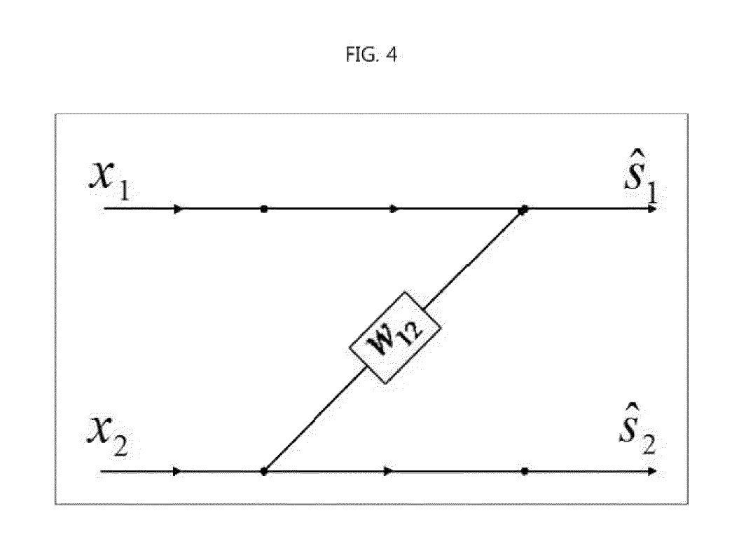

FIG. 4 is a diagram of a backward model of the forward model of the modified BSS algorithm in FIG. 3. The relationship between the sound source signal and the input signal in the backward model shown in FIG. 4 may be expressed by Equation 13.

s₁(t)=w₁₁x₁(t)+w₁₂x₂(t)

s₂(t)=w₂₂x₂(t) [Equation 13]

At this time, when a gain of voice signal input into the voice recognition sensor is 1 and, because the sound source signal is a known signal output from the apparatus for signal separation, one of the sound source signal output from the second sound source (for example, speaker) is also 1, w₁₁ and w₂₂ are 1. And w₂₁ is 0, so that the matrix W may be a simple matrix which has one unknown quantity. That is, w(ω) may be expressed by Equation 14.

$$W ( ω ) = [ \begin{matrix}1 & {w}_{12} \\ 0 & 1\end{matrix} ] \qquad [ Equation 14 ]$$

E(ω,t) denoting an error of the cross-correlation between sound sources is also 2×2 matrix. At this time, the elements (1,2) and (2,1) in the E(ω,t) should be close to 0 to estimate ideal \hat{Λ}ₛ, because it has been assumed that there is no correlation between the sound sources.

Thus, referring to Equation 9, when W is developed by the Equation 10 with substitution the Equation 14, an adaptive weighting factor about w₁₂ may be obtained.

With the above result, when it is applied to each frequency of the mixed signal, it is possible to obtain only the desired sound source signal while reducing unnecessary signal.

Since the used matrix W as shown in FIG. 14 may be expressed with triangular matrix whose elements at the opposite angle are 1, the operation load could be noticeably lessened comparing to when applying the conventional BSS algorithm.

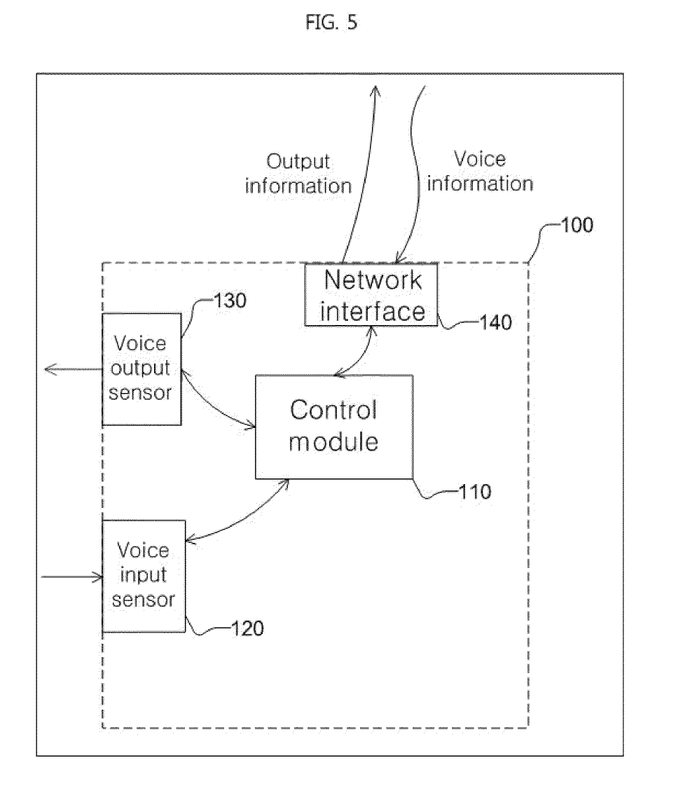

FIG. 5 is a diagram illustrating schematic composition of a communication system according to another exemplary embodiment of the present inventive concept. Referring to FIG. 5, the communication system 100 includes a control module 110 and a voice input sensor 120. The communication system 100 further includes a voice output sensor 130 and/or a network interface 140. The communication system 100 may denote including all of the data processing apparatus enabling to transmit/receive voice information to/from systems in a remote distance (for example, mobile phone, notebook, computer, etc.) by wire/wireless communication. The communication system 100 may further include audio encoder/decoder (not shown) and RFT packing/unpacking module (not shown) which belong to conventional communication system, but to clarify main features of the present inventive concept, the details for them will be omitted.

The control module 110 may be implemented by combination of software and/or hardware according some embodiments of the present inventive concept, and it may denote logical composition performing functions would be described later. Therefore, the control module 110 may not necessarily denote being implemented as a physical apparatus. The control module 110 may perform the modified BSS algorithm according to some embodiments of the present inventive concept.

The voice input sensor 120 is for receiving external signal and may be embodied as a microphone, but the embodiment is not restricted thereto.

The communication system 100 may receive voice information from other communication system (for example, cellular phone of the other party). The received voice information may be output via the voice output sensor 130. At this time, the communication system 100 may store the voice information temporarily. Thereafter, the communication system 100 may receive a mixed signal wherein a first signal (for example, user's voice the gain factor is considered) based on a first sound source signal (for example, user's voice) and a second signal (for example, a second signal the gain factor is considered) based on a second sound source signal (for example, signal to be output from a speaker) are mixed, via a single voice input sensor 120.

Then, the control module 110 may apply the modified BSS algorithm to separate the first sound source signal and the second sound source signal based on the mixed signal, so that the first sound source signal may be separated from the mixed signal. Separating the first sound source signal may not denote that the separation result is completely identical with the first sound source signal, but may denote the process for obtaining the first sound source signal might be estimated by the operation.

Also, applying the modified BSS algorithm may denote a series of process that when it is set the first sound source signal to be a first BSS sound source signal s1(t), the second sound source signal to be a second BSS sound source signal s2(t), the mixed signal input via the voice input sensor 120 to be a first BSS input signal x1(t), and the signal output via the voice output sensor 130 to be a second BSS input signal x2(t), the first sound source signal is obtained by the BSS algorithm. The voice output sensor 130 may be embodied as a speaker, but the embodiment is not restricted thereto, and it may include all of the apparatus enabling to output, which are included in the communication system 100. At this time, the second BSS sound source signal s2(t) is an output signal output from the voice output sensor 130 as a result of the voice information from other communication system (for example, cellular phone of the other party) undergone a predetermined process (for example, unpacking, audio decoding, etc.), thus, it is a known signal.

As described above, although a voice output from the voice output sensor 130 is input via the voice input sensor 120 again, the communication system 100 may separate only the first sound source signal (for example, user's voice) in real time. Thus, echo canceling may be performed, and the separated first sound source signal may be transmitted to other communication system (for example, other cellular phone, etc, not shown) via the network interface module 140. Thus, other communication system may not need to perform echo canceling and double-talk detection. Also, it is effective in implementing a full-duplex communication system. In addition, in separating the desired signal from the mixed signal in which two signals are mixed by using the modified BSS algorithm, since one of the two signals is a known signal, it is not necessary to include always at least two voice input sensors, which results in reducing physical consumption.

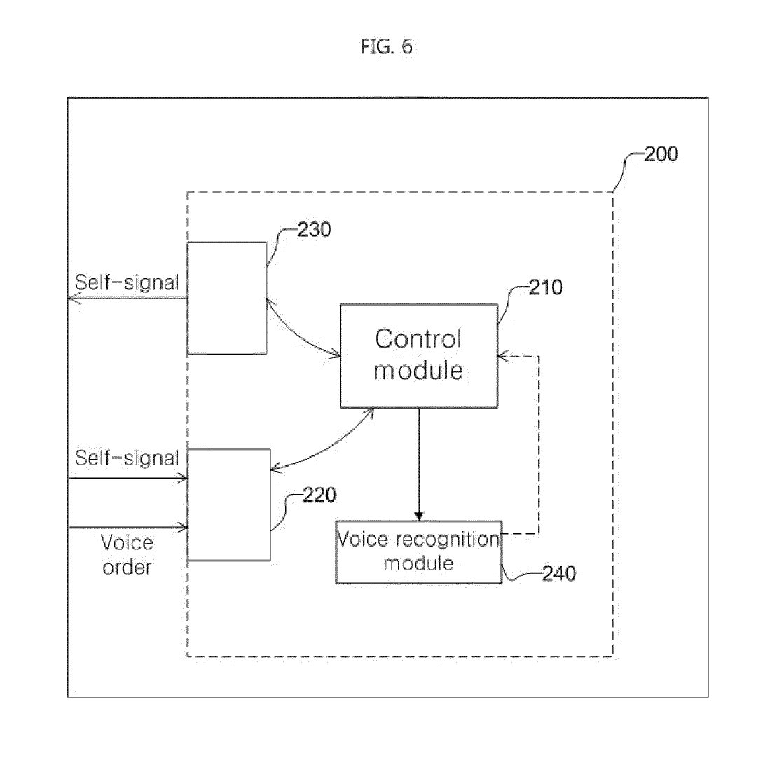

FIG. 6 is a diagram illustrating schematic composition of a voice recognition system according to yet another exemplary embodiment of the present inventive concept. Referring to FIG. 6, the voice recognition system 200 includes a control module 210, a voice input sensor 220, and a voice output sensor 230. And the voice recognition system 200 further includes a voice recognition module 240. In some embodiments, the control module 210 may perform a function of the voice recognition module 240.

The control module 210 may be implemented by combination of software and/or hardware according to some embodiment of the present inventive concept, and may denote logical composition performing functions would be described later. Therefore, the control module 210 may not necessarily denote being implemented as a physical apparatus. The control module 210 may perform the modified BSS algorithm according to some embodiment of the present inventive concept. In some embodiments, the control module 210 may perform voice recognition. Hereinafter, for convenience of explanation, it is taken as an example that the separate voice recognition module 240 performs voice recognition function, but range of claim in the present invention is not restricted thereto.

The voice recognition system 200 may receive a mixed signal wherein a first signal (for example, user's voice the gain factor is considered) based on a first sound source signal (for example, user's voice) and a second signal (for example, speaker sound the gain factor is considered) based on a second sound source signal (for example, speaker sound) are mixed via the voice input sensor 220. That is, the voice recognition system 200 may receive self outputting signal (for example, broadcasting sound, music sound, etc.) together with the user's voice order.

Then, the control module 210 may apply the modified BSS algorithm to separate the first sound source signal based on the received mixed signal.

The separated first sound source signal (for example, user's voice order) may be transmitted to the voice recognition module 240, and the voice recognition module 240 may recognize the first sound source signal as a voice order. The recognized voice order may be transmitted to the control module 210, and based on the order information, the control module 210 may perform an operation corresponding thereto.

As described above, the voice recognition system 200 according to yet another exemplary embodiment of the present inventive concept, may separate the first sound source signal from the mixed signal input via the voice recognition sensor 220 regardless of the loudness or kinds of self outputting sound. Therefore, there is an effect that it is not necessary to lower the loudness of self outputting sound or to convert into a separate mode like in the conventional voice recognition system, so that the voice recognition may be simply performed.

The voice recognition system 200 may be embodied as at least one of navigation, TV, IPTV, conference call, home network system, robot, game machine, electronic dictionary, and language learning machine.

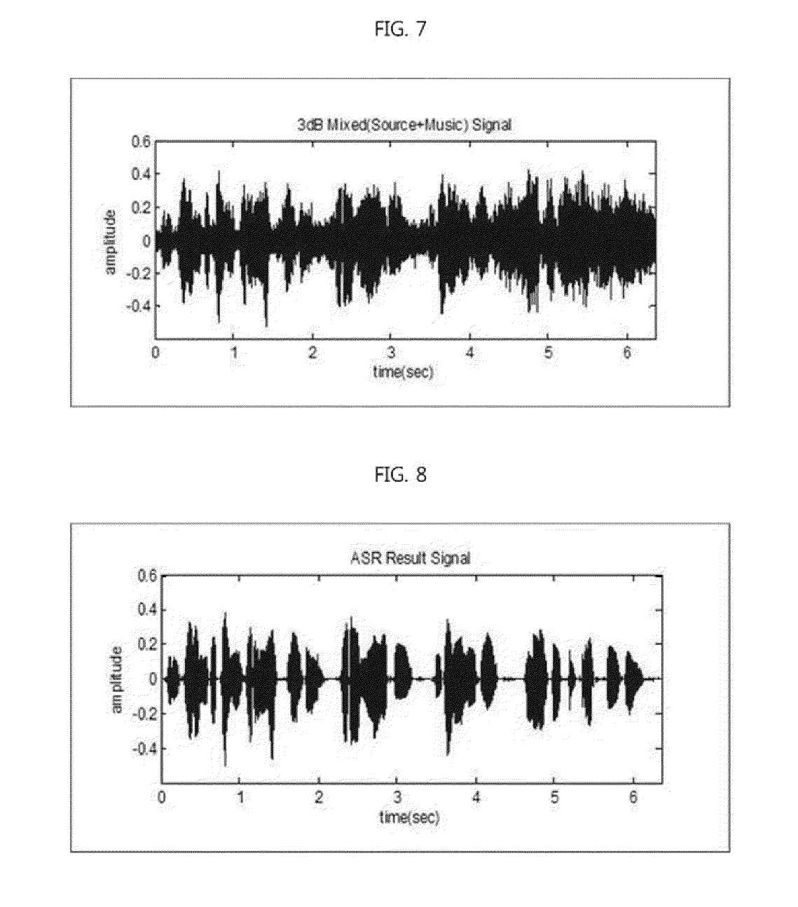

FIG. 7 through FIG. 12 are diagrams for explaining test outcomes of performing signal separation by using the method for signal separation according to some exemplary embodiments of the present inventive concept.

For verification of the method for signal separation according to some exemplary embodiments of the present inventive concept, an experiment was performed by using MATLAB. Firstly, using largely two kinds of sound source signals of voice and music, the music signal was mixed with the voice signal which is the main signal, and then, the music signal was tried to be removed. In addition, by using Aurora 2 DB having been widely used for testing voice recognizer, the voice signal and the music signal were mixed with test DB, so that the efficiency of voice recognizer before and after the method for signal separation according to some exemplary embodiments of the present inventive concept was applied might be tested.

Since the objective system was the recognizer receiving the voice order, Wave Format which has been used mainly for voice, was used as a form of sound source. That is, sampling rate was a form of 8kJz, 16 bit signed signal. Likewise, the unwanted signal would be mixed with the main sound source had the same form, and Man anchor's speech in TV news and classical music were used, respectively, for the unwanted signal.

The length of Short Time Fourier Transform (STFT) was defined with reference to 256 samples. When a length of filter is longer, resolution between frequencies is higher, so that it has an effect on efficiency increase, but complexity of the operation is also higher, the time for the operation needs to be considered. Also, it was designed to overlap 50% using Overlap-add Method, and Harming Window was used for window function.

Meanwhile, as described above, Aurora 2 DB was used as a database to verify the efficiency of the voice recognizer. Aurora was proposed by ETSI Aurora Project in Europe and was designed for evaluation of Europe standard voice recognition. It is composed of clean training DB, multicondition training DB and test DB. Aurora DB actually aims at testing a noise canceling filter in stationary noise signal background. However, the method for signal separation according to some exemplary embodiments of the present inventive concept aims at canceling a non-stationary signal not a stationary noise signal, thus, the separate test DB was proposed for the test. The test DB was prepared in a way of the classical music and the voice being mixed on a clean test DB, respectively. Energy ratio of the signal to be mixed was designed to have SNR(signal-to-noise ratio) of 20 dB, 15 dB, 10 dB, 5 dB, 0 dB, −5 dB. Since noise is mixed privately also in Aurora 2 DB not using the sound source recorded in actual noise background, it may be determined that the way used in the experiment for verifying the method for signal separation according to some exemplary embodiments of the present inventive concept is also not against the standard. In addition, since the purpose of the verification is to check the change of the efficiency before and after applying the method not to evaluate the voice recognizer, this experiment is meaningful enough.

FIG. 7 is the result when the music signal was mixed with the voice signal which is the main signal. The energy ratio of voice to music was about 3 dB, which was 2 to 1.

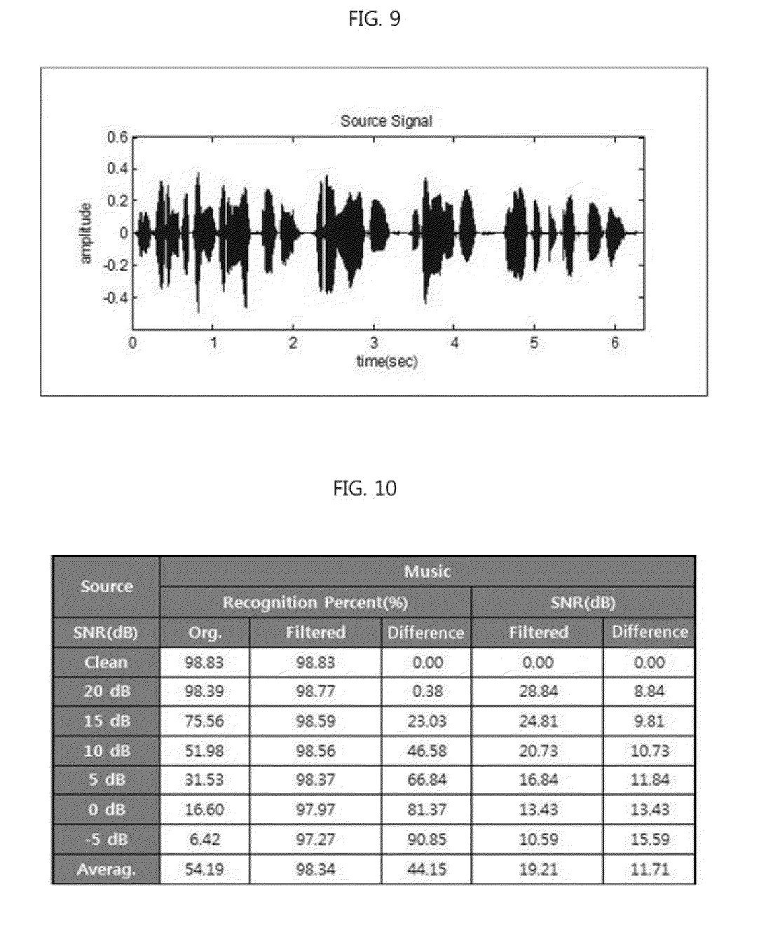

FIG. 8 is a signal graph showing the result of performing the method for signal separation according to some exemplary embodiment of the present inventive concept to the mixed signal shown in FIG. 7. FIG. 9 is a signal graph of the original voice.

Comparing FIG. 8 with FIG. 9, the result signal is almost identical to the original voice signal, thus, it can be inferred that the music signal was decreased noticeably, which is also visible to the naked eye. The result of SNR measurement is 16.3 dB, which denotes improvement of more than 13 dB, and the coefficient of signal correlation is 0.9883, which denotes the similarity of greater than 98%.

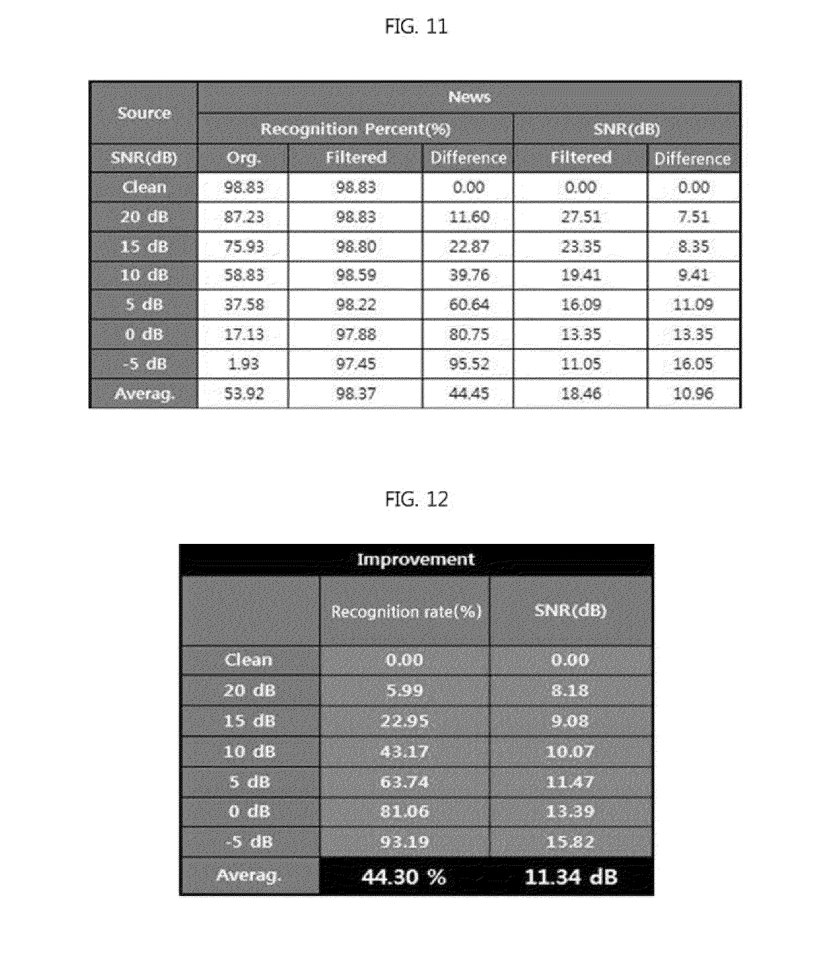

FIG. 10 through FIG. 12 are tables showing the result of applying the voice recognition DB. In the voice recognition DB, 1001 kinds of voice orders were used as voice signals. First, the classical music and the voice were mixed on clean DB, respectively, and the recognition test was done. The result is shown in FIG. 10. And the news speech and the voice were mixed on the clean DB, respectively, and the recognition test was done. The result is shown in FIG. 11. FIG. 12 shows the improvement of average voice recognition rate. Referring to FIG. 12, there was improvement of more than 44% in average voice recognition rate and of efficiency of more than 11 dB. The recognition rate and SNR increased much more when more background signals were mixed, that is, when SNR of the mixed signal was lower. As a result, it can be inferred that when the method for signal separation according to some exemplary embodiments of the present invention is performed in a proper condition, the voice recognition rate is maintained to be stable regardless of level of the unwanted signal.

The method for signal separation according to some exemplary embodiments of the present inventive concept, may implemented in computer readable codes on a computer readable recording medium. The computer readable recording medium is any data storage device that can store data which can be thereafter read by a computer system. Examples of the computer readable recording medium may include read-only memory (ROM), random-access memory (RAM), CD-ROM, magnetic tape, hard disk, floppy disk, and optical data storage, and may also include a medium embodied into a carrier-wave form.

As described above, the method for signal separation and the system using the same according to exemplary embodiments of the present inventive concept have an effect of separating a mixed signal from at least two different sound sources effectively.

And, the communication system using the method for signal separation performs echo cancelling by using a voice signal received from other communication system and transmits the echo-cancelled signal to the other communication system, so that double-talk detection may not be performed.

In addition, operation overload for signal separation can be reduced drastically compared to the conventional BSS algorithm, so that waste of time and resource is less.

In a voice recognition system using the method for signal separation, it is not necessary to reduce level of a signal of the system itself and enter separate mode for voice recognition, so that a user friendly UI (User Interface) environment can be provided.

While the inventive concept has been particularly shown and described with reference to exemplary embodiments thereof, it will be understood that various changes in form and details may be made therein without departing from the spirit and scope of the following claims.

1. A method for signal separation which is performed by an apparatus for signal
separation, the method comprising:
receiving a mixed signal, wherein a first signal based on a first sound source signal and a second signal based on a second sound source signal are mixed, via a single voice input sensor;
applying a modified BSS algorithm for separating the first sound source signal and the second sound source signal based on the mixed signal; and
separating the first sound source signal according to the result of applying the modified BSS algorithm.

2. The method of claim 1, wherein, the second sound source signal is the signal to be output via a voice output sensor included in the apparatus for signal separation.

3. The method of claim 2, wherein applying BSS algorithm in the modified BSS algorithm comprising:
setting the first sound source signal and the second sound source signal to be a first BSS sound source signal and a second BSS sound source signal, respectively; and
setting the mixed signal input via the voice input sensor and the output signal output via the voice output sensor to be a first BSS input signal and a second BSS input signal, respectively.

4. The method of claim 3, wherein the first BSS input signal and the second BSS
input signal are expressed by Equation 1.
x₁(t)=a₁₁s₁(t)+a₁₂s₂(t)
x₂(t)=a₂₂s₂(t) [Equation 1]

5. The method of claim 3, wherein the first sound source signal and the second sound source
signal are expressed by Equation 2.
s₁(t)=w₁₁x₂(t)+w₁₂x₂(t)
s₂(t)=w₂₂x₂(t) [Equation 2]

6. The method of claim 5, wherein, the function W is expressed by Equation 3.
$$W ( ω ) = [ \begin{matrix}1 & {w}_{12} \\ 0 & 1\end{matrix} ] \qquad [ Equation 3 ]$$

7. The method of claim 1, wherein the apparatus for signal separation is embodied as a communication system, wherein the first sound source signal is a user's voice signal and the second sound source signal is an output signal to be output via the voice output sensor based on voice information received from other communication system.

8. The method of claim 7 further comprising storing the voice information.

9. The method of claim 1, wherein the apparatus for signal separation is embodied as a voice recognition system, wherein the first sound source signal is processed as a voice recognition order.

10. The method of claim 1, wherein the voice input sensor is embodied as a micro-phone.

11. A computer readable medium which programs for performing the method described in claim 1.

12. A communication system comprising:
a voice input sensor; and
a control module,
wherein a mixed signal in which a first signal based on a first sound source signal and
a second signal based on a second sound source signal are mixed is received via a single voice input sensor; and
wherein the control module applies the modified BSS algorithm for separating the first sound source signal based on the mixed signal and separates the first sound source signal according to the result of applying the modified BSS algorithm.

13. The communication system of claim 12 further comprises a voice output sensor; and
wherein the second sound source signal is the signal to be output via the voice output sensor.

14. The communication system of claim 12 further comprising:
a network interface module; and
wherein the separated first sound source signal is transmitted to other communication system via the network interface module.

15. The communication system of claim 12, wherein applying BBS algorithm in the modified algorithm comprising:
setting the first sound source signal and the second sound source signal to be a first BSS sound source signal and a second BSS sound source signal, respectively; and
setting the mixed signal input via the voice input sensor and the output signal output via the voice output sensor to be a first BSS input signal and a second BSS input signal, respectively.

16. The communication system of claim 12 is embodied as at least one of wire/wireless telephone, mobile phone, computer, IPTV, IP phone, Bluetooth communication apparatus and conference call.

17. A voice recognition system comprising:
a voice input sensor;
a voice output sensor; and
a control module,
wherein a mixed signal in which a first signal based on a first sound source signal and a second signal based on a second sound source signal are mixed is received via the voice input sensor; and
wherein the control module applies the modified BSS algorithm for separating the
first sound source signal based on the mixed signal and separates the first sound source signal according to the result of applying the modified BSS algorithm.

18. The voice recognition system of claim 17, wherein applying BSS algorithm in the modified BSS algorithm comprising:
setting the first sound source signal and the second sound source signal to be a first BSS sound source signal and a second BSS sound source signal, respectively; and
setting the mixed signal input via the voice input sensor and the output signal output via the voice output sensor to be a first BSS input signal and a second BSS input signal, respectively.

19. The voice recognition system of claim 17 processes the separated first sound source signal as a voice order to perform an operation corresponding to the voice order.

20. The voice recognition system of claim 17 is embodied as at lease one of navigation, TV, IPTV, conference call, home network system, robot, game machine, electronic dictionary, and language leaning machine.
